(19) United States
(12) Patent Application Publication
(10) Pub. No.: US 2014/0137806 A1
(43) Pub. Date: May 22, 2014

(54) AQUACULTURE FEEDS CONTAINING SOY PROTEIN AND FISHMEAL AND METHODS OF MAKING AND USING SAME

(71) Applicant: PURINA ANIMAL NUTRITION LLC, Shoreview, MN (US)

(72) Inventors: Bill L. Miller, Labadie, MO (US); Elizabeth Allison Koutsos, Apex, NC (US)

(73) Assignee: Purina Animal Nutrition LLC, Shoreview, MN (US)

(21) Appl. No.: 13/679,014

(22) Filed: Nov. 16, 2012

(51) Int. Cl. A23K 1/10; A01K 61/00; A23K 1/18

(52) U.S. Cl. CPC A23K 1/103; A23K 1/188; A01K 61/00
USPC 119/200; 426/442; 426/657

(57) ABSTRACT

Aquaculture feeds include a combination of proteinaceous vegetable material and proteinaceous fish material. The vegetable and fish materials are combined with additives such as alcohol and reducing agents and heated at elevated temperatures to release oil and nutrients from the fish material. At least a portion of the oil is absorbed into the proteinaceous vegetable material to form a proteinaceous product from the mixture. Alcohol is removed from the mixture to form the aquaculture feed with enhanced protein digestibility and solubility. The aquaculture feed may include up to about 50 percent proteinaceous vegetable material and up to about 50 percent proteinaceous fish material. Aquaculture species ingesting diets of the aquaculture feed experience improvements in weight gain, protein conversion efficiency, and feed efficiency compared to aquaculture species ingesting diets of fishmeal alone or soy flake produced according to traditional methods.

### FIELD OF TECHNOLOGY

The present disclosure relates to aquaculture feed containing proteinaceous vegetable materials with less anti-nutritional factors (“ANF”) than traditional proteinaceous vegetable materials in combination with fishmeal and derivatives thereof, and methods of making and using the same. More particularly, the combination of the proteinaceous vegetable materials with fishmeal and fishmeal derivatives provides a feed that optimizes growth of aquaculture species with improvements compared to the use of fishmeal alone.

### BACKGROUND

Prior approaches to raising aquaculture species involved feeding fishmeal for growth and development. Fishmeal is typically a brown powder or cake made from drying marine fish or fish trimmings. The marine fish used to produce the fishmeal are typically small and contain a high percentage of bones and oil, and thus are usually not used for human consumption. Fishmeal has been commonly used as aquaculture feed due to its high crude protein and amino acid content and its palatability. Aquaculture species generally ingest the fishmeal quickly, which reduces nutrient leaching into the water.

However, due to the heavy reliance on fishmeal in aquaculture production, ecological impacts are a concern for scientists and conservationists that observe negative impacts on marine food chains due to the harvesting of the marine fish feedstock. Because fishmeal is produced by harvesting certain types of fish during a set season, negative environmental or biological conditions may hinder production. For example, fishmeal production is curtailed greatly by oil spills in regions where the marine fish are harvested. Therefore, sustainability of fishmeal production at its current levels is uncertain. Further, fishmeal is generally produced near the sight of harvest, and thus shipping fishmeal to inland locations results in an increased cost for the producer. As the demand for aquaculture increases, the use of fishmeal alone in feeding aquaculture species may negatively impact the environment, sustainability of production may not be possible and may be unstable due to environmental factors.

### SUMMARY

In view of the foregoing, replacements or alternatives to fishmeal in aquaculture feed are needed in order to ensure feed supply availability while not negatively impacting growth of aquaculture species. Aquaculture feeds, and methods of making and using the aquaculture feeds are provided according to the present disclosure in which the feeds contain fishmeal or fishmeal derivatives in combination with proteinaceous vegetable materials with less anti-nutritional factors (“ANF”) relative to traditional proteinaceous vegetable materials.

According to one aspect of the present disclosure, a method of forming an aquaculture feed involves combining a proteinaceous vegetable material with a proteinaceous fish material, alcohol and a reducing agent to form a mixture. The mixture is maintained under pressure at a cooking temperature sufficient to cook the proteinaceous fish material and release oil therefrom. At least a portion of the oil is absorbed into the proteinaceous vegetable material to form a proteinaceous product from the mixture. All or essentially all of the alcohol is removed by venting the pressure on the proteinaceous product to form the aquaculture feed, the aquaculture feed with enhanced protein digestibility and solubility.

According to another aspect of the present disclosure, a method of forming an aquaculture feed involves combining a proteinaceous vegetable material with alcohol and a reducing agent to form a mixture and maintaining the mixture at a temperature greater than 90° C. and a pressure greater than 10 psig for a holding period of at least about five minutes. The heated and pressurized proteinaceous vegetable material is processed with a proteinaceous fish material containing released oil, wherein at least a portion of the released oil is absorbed into the proteinaceous vegetable material. All or essentially all of the alcohol is removed by venting the pressure on the proteinaceous product to form the aquaculture feed, the aquaculture feed with enhanced protein digestibility and solubility.

In yet another aspect of the present disclosure, a method of feeding aquaculture species involves providing the aquaculture species an aquaculture feed formed of about 50 percent or more proteinaceous vegetable material and up to about 50 percent proteinaceous fish material, wherein the proteinaceous vegetable material includes a glycinin level of not more than 11 mg/g and a β-conglycinin of not more than 0.4 mg/g.

### DETAILED DESCRIPTION

The present disclosure generally relates to aquaculture feeds containing processed vegetable protein, e.g., soy protein, in combination with fishmeal and methods of producing and using such feeds. More particularly, aquaculture feeds may be produced by processing vegetable protein to enhance its digestibility and solubility and to reduce its antigenicity. The vegetable protein may be processed alone or in combination with fishmeal during such feed production. It has been discovered that the processed vegetable protein in combination with fishmeal results in improvements to aquaculture performance compared to feeding the aquaculture fishmeal alone. Further, relative to quality animal proteins processed vegetable protein including the processed soy proteins of the present disclosure are generally cheaper alternatives.

The processed vegetable protein of the present disclosure is in contrast to soybeans or traditionally processed soybeans in the form soy flours, soy flakes, and soy meal that generally have off-flavors that are unpalatable to aquaculture due to their relatively higher antigenicity. The proteinaceous vegetable products provided in the aquaculture feeds according to the present disclosure contrastingly exhibit a lower concentration of antigenic proteins, such as glycinin and β-conglycinin. The products also exhibit increased solubility (increased Protein Dispersibility Index or “PDI”), which may be improved by at least 2.75 PDI units and by as much as about 4.8 PDI units, or even more. The proteinaceous vegetable products are further provided with enhanced digestibility. Some non-exhaustive examples of suitable vegetable protein sources that may be processed according to the methods herein include oilseeds, grains, and legumes. An exemplary oilseed source includes soybeans. Examples and descriptions of the vegetable protein sources, in native and processed forms, that may be suitable for use according to the present disclosure, and the methods of processing proteinaceous vegetable material that may be used in accordance with the present disclosure are provided in U.S. Pat. No. 7,608,292, entitled “Method of Processing Soy Protein,” filed on Oct. 14, 2003, which is hereby incorporated by reference in its entirety.

The proteinaceous fish material in the aquaculture feeds of the present disclosure may have increased protein availability and reduced antigenicity, and may provide enhanced digestibility while avoiding negative impacts on palatability. The proteinaceous fish material provides a source of oils and nutrients that may be absorbed by the proteinaceous vegetable materials or products. Proteinaceous fish material may include fishmeal and fishmeal precursors such as raw fish and processed fish having been processed through cooking, pressing, drying, grinding, or combinations thereof. A nutrient composition of the proteinaceous fish product may include polyunsaturated fatty acids (PUFA) such as omega-3 and omega-6 fatty acids, which provides usable energy for aquaculture.

In addition, the processed vegetable protein as well as the proteinaceous fish material may be prepared with a reducing agent, for example, to chemically reduce and/or reverse disulfide linking (R—S—S—R) in the vegetable and animal proteins that may result from oxidative coupling of two sulfhydryl groups (R—SH). The inclusion of alcohol with the reducing agent in the preparation of the proteinaceous vegetable and fish materials may help support and increase the beneficial action of the reducing agent on the proteins.

Generally, the reducing agent that may be included in the processes of the present disclosure may be any chemical agent, substance, compound, or mixture, whether in gaseous, liquid, or vapor form, that is, or produces a material that is, (1) capable of donating electrons in a chemical reduction reaction or (2) capable of chemically reducing and/or reversing disulfide linking (R—S—S—R) in protein that may result from oxidative coupling of two sulfhydryl groups (R—SH). Some non-exhaustive examples of such sulfur-containing compounds include sulfur dioxide (S0₂) or a source of sulfur dioxide, such as an S0₂-generating precursor. Other suitable reducing agents that may be suitable for use according to the present disclosure are provided in U.S. Pat. No. 7,608,292 previously incorporated by reference. The concentration of the reducing agent in the intermediate mixture to be reduced may generally be about 0.01 weight percent, or more, based on the total weight of the intermediate mixture, with an upper end concentration maximum of about 3 weight percent to about 4 weight percent.

The alcohol that may be included in the processes of the present disclosure facilitates solubilizing any undesirable flavor components that may be present in the vegetable protein source and in the fish protein source. After being solubilized with alcohol, volatilization of the alcohol along with water supports removal of solubilized undesirable flavor components originally present in the protein sources. The alcohol may also modify the fish protein making the protein more available for digestion and may release oils within the tissue. The alcohol may additionally kill bacteria present in the fish protein. Alcohols that may optionally be employed according to the present disclosure include methyl alcohol (methanol), ethyl alcohol (ethanol), N-propyl alcohol (1-propanol), and isopropyl alcohol (isopropanol). The concentration of the alcohol in the intermediate mixture may generally range from about 5 weight percent to about 20 weight percent, based on the total weight of the intermediate mixture, with a concentration of the alcohol ranging from about 10 weight percent to about 15 weight percent, based on the total weight of the intermediate mixture, being desirable. In some implementations, when both the fish and vegetable proteins are treated with alcohol, the concentration of the alcohol may be increased or may remain the same.

Methods of producing the aquaculture feeds including fishmeal and vegetable protein involve combining the vegetable protein, such as soy protein, one or more of the reducing agent and alcohol, optionally water, and optionally fishmeal or fishmeal precursors to form an intermediate mixture. The intermediate mixture may be heated, optionally under pressure, for a select period of time to allow reactive interaction of the components present in the intermediate mixture. The temperature of the intermediate mixture within the processing apparatus may generally be greater than ambient temperature, such as at temperatures greater than about 90° C. and below about 120° C., and in some implementations may range from between about 95° C. and about 100° C. The pressure on the intermediate mixture within the autoclave or vessel may be greater than atmospheric (super-atmospheric) and may range from about 10 pounds per square inch gauge (psig) to about 30 psig. The time the intermediate mixture is held within the processing apparatus may be at least about 5 minutes long, preferably is at least about 10 minutes long, and more desirably is from about 10 minutes long to about 30 minutes long.

Any pressure may be vented to atmospheric pressure to support evaporation of water and alcohol along with any undesirable flavor components and odor components dissolved in the alcohol, and all, or essentially all, of the alcohol may be removed.

After the select period of time, the temperature on the proteinaceous product may be allowed to drop to ambient temperature, such as to a temperature of about 22° C. (72° F.).

The intermediate mixture may be processed using a processing apparatus adapted to withstand elevated temperature and pressure conditions, which may include a pressure cooker or a continuous cooker. Steam may be introduced into the processing apparatus for purposes of increasing the temperature, and optionally the pressure. Furthermore, when employing pressure, the intermediate mixture may be placed within the vessel either before or after the vessel has been pressurized. Additionally, the vessel may be equipped with a suitable mixer, blender or combination thereof that supports compilation, preparation and optional chopping of the intermediate mixture in the vessel.

Upon processing the proteinaceous vegetable material, alone or in combination with the proteinaceous fish material, a proteinaceous product may be formed in which the portion formed of the proteinaceous vegetable material includes an enhanced digestibility and solubility and a reduced antigenicity. When the proteinaceous fish material is present, the proteinaceous product formed may provide an aquaculture feed containing the proteinaceous vegetable material in combination with the proteinaceous fish material with reduced antigenicity and increased digestibility.

The proteinaceous product or the aquaculture feed may be dried using any conventional drying apparatus, such as a drum dryer or a vacuum dryer, to reduce the moisture content of the proteinaceous product to about five weight percent, or less, based on the total weight of the proteinaceous product or aquaculture feed. As other suitable examples, drying may be through air-drying, using a fan or blower, or a vacuum. After being dried, the proteinaceous product or the aquaculture feed may optionally then be ground to a desired particle size range, such as to the consistency of a meal or flour.

In some implementations, and as provided above, the intermediate mixture, the proteinaceous product, or both, may be free of the proteinaceous fish material during some processing stages, such as during an initial heating and pressurizing stage of the intermediate mixture, and the proteinaceous fish material may be added to during formation of the intermediate mixture or the proteinaceous product.

When the proteinaceous fish material is present in the intermediate mixture, the mixture may be held for a time sufficient to cook the fish to a level of completion that enables the oils and nutrients within tissue to be released. For example, when heated to a temperature of at least about 95° C., the intermediate mixture containing the proteinaceous fish material may be held for a period of from about 15 minutes to about 20 minutes. Alternatively, the intermediate mixture containing the proteinaceous fish material may be heated to temperatures and held for any of the holding times of the present disclosure in order to release oils and nutrients. Prior to introduction into the intermediate mixture, the proteinaceous fish material may be processed such as through cooking, pressing, drying and/or grinding or may be formed as fishmeal.

In another example, the intermediate mixture may be free of the proteinaceous fish material and be subjected to a first treatment for reducing the antigenicity and increasing the dispersibility and digestibility of the proteinaceous vegetable material described above. A second treatment may involve adding proteinaceous fish material to the treated intermediate for further processing, such as processing at different temperatures, pressures or both, compared to the first treatment. The second treatment may subject the mixture to temperatures and pressures for sufficiently cooking the proteinaceous fish material, when not cooked; for causing oils to be released from the material; for causing the fish material to make the protein more digestible or for reducing antigenicity, such as through treatment with alcohol; and combinations thereof. In another example, the proteinaceous fish material may be added to the proteinaceous vegetable material after removal of all or substantially all of the alcohol therefrom. The proteinaceous vegetable product may be dried and ground into particulates prior to or after introduction of the proteinaceous fish material.

Processing the proteinaceous fish material, according to the present disclosure, may cause oils and other nutrients to be released from tissue, making the oils and nutrients from the fish available for absorption by the vegetable protein to provide an aquaculture feed with enhanced nutrients derived from the proteinaceous fish material. Such processing may involve subjecting the proteinaceous fish material to the processing conditions of the intermediate mixture, or through separate cooking, alcohol treatment, reducing agent treatment, pressurizing, pressing or other extraction processes. For example, where the proteinaceous fish material is processed to extract excess oil, such as through one or more of heating, treating with alcohol, pressing and combinations thereof, and where the vegetable protein is present, some oils may be retained within the mixture due to oil absorption by the vegetable protein. When not present during oil-extraction processing, the vegetable protein may absorb the remaining oils upon their introduction.

In addition, processing the proteinaceous fish material under elevated temperatures and/or pressures may open the structure of the fish protein making the protein more digestible for aquaculture species. In the presence of alcohol, the fish protein structure may also be modified to increase the availability of protein and therefore increase digestibility and additionally or alternatively to reduce antigenicity. Further, processing the proteinaceous fish material under the elevated temperatures and/or pressures generally kills antigens present in the proteinaceous fish material.

In further implementations, the proteinaceous vegetable product with its enhanced digestibility and solubility and reduced antigenicity may be added to raw fish or other fishmeal precursors prior to processing into the aquaculture feed formed of the fishmeal and the proteinaceous vegetable product. The proteinaceous vegetable product may be formed according to the methods described above, including according to the disclosure of U.S. Pat. No. 7,608,292 previously incorporated by reference, and combined with the raw fish or other fishmeal precursor. The mixture may be heated to temperatures for a time sufficient to cook the fish or fishmeal precursor to a level of completion that enables the oils within tissue to be released. Alternatively, the fishmeal precursor may be cooked or heated separately and the proteinaceous vegetable product may be added to the mixture. The fishmeal production process may further involve alcohol treatment, reducing agent treatment, pressing and/or grinding according to the present disclosure. For example, the production process may involve pressing the mixture to remove excess oils. Pressing may occur prior to combining or after combining with the proteinaceous vegetable product. In another example, the mixture may be ground, and additional oils within the fishmeal precursor may be released. By combining the proteinaceous vegetable product during production of the fishmeal, the resulting aquaculture feed may include enhanced nutrients derived from the proteinaceous fish material along with the proteinaceous vegetable product with its reduced antigenicity and increased dispersibility and digestibility.

The aquaculture feeds produced according to the present disclosure may be formed of about 50 percent or between about 50 and about 70 percent proteinaceous vegetable product, and up to about 50 percent or between about 30 and about 50 percent fishmeal. In some aspects, poultry meal, meat meal, blood meal, and combinations thereof, may be included in the aquaculture feed products and may replace a portion of the proteinaceous vegetable product, the fishmeal or both.

From Table A below, the antigen level present in the proteinaceous vegetable material processed according to the present disclosure may be less, and in some cases significantly less, compared to non-processed white flake (processed with no or only low heat with most of the fat removed and having a PDI in the range of 88-90) or traditionally processed white flake (processed without a reducing agent).

TABLE A
Soy Antigen Levels, ppm

| | Glycinin | Beta Conglycinin | Trypsin Inhibitor, |
|---|---|---|---|
| | mg/g | mg/g | mg/g |
| Non-processed | Above definable | Above definable | 28 |
| white flake | levels | levels | |
| traditionally | 20 | 1.2 | 1.4 |
| processed | | | |
| white flake | | | |
| White | 11 | 0.4 | 0.5 |
| flake processed | | | |
| according to | | | |
| the present | | | |
| disclosure | | | |

According to Table A, the processed proteinaceous vegetable material within the aquaculture feeds of the present disclosure include a glycinin level of not more than 11 mg/g, a β-conglycinin of not more than 0.4 mg/g and a trypsin inhibitor of not more than 0.5 mg/g.

It has been found that feeding aquaculture species the aquaculture feeds produced according to the present disclosure results in improved performance compared to feeding fishmeal alone, and results in substantially improved performance compared to feeding soy flakes processed according to prior approaches. In particular, aquaculture species ingesting a diet of aquaculture feed produced according to the present disclosure were not negatively impacted by ingesting such a diet and showed improvements in protein conversion efficiency, proximate body composition, and feed efficiency compared to aquaculture species ingesting a diet of fishmeal alone, and showed substantial improvements in these responses compared to aquaculture species ingesting a diet of soy flake produced according to traditional methods.

The present disclosure is applicable to aquaculture species generally, and may apply to juvenile fish such as fingerling fish with a starting weight of about 2.5 grams or a length of about 3-4 inches. Aquaculture species that may ingest the aquaculture feed of the present disclosure include all marine fish species, such as but not limited to, carnivorous species including cobia, salmon, trout, hybrid striped bass, and bluegill. These carnivorous species may particularly benefit from the aquaculture feed as these species are generally intolerant of feed formed of traditional soybean meal and traditional soy protein concentrate. Other species include omnivores including but not limited to catfish and tilapia. Further, shrimp, such as shrimp at juvenile stages may benefit from the aquaculture feed.

Aspects of the present disclosure are described in the following Example, which is intended for illustration only, and those skilled in the art will appreciate that modifications and variations may be made without departing from the scope of the present disclosure.

### EXAMPLE

A comparative feeding trial was conducted to evaluate soy isolate ingredients as a partial replacement for fishmeal in commercial aquaculture diets. The trial was conducted according to nutrient profiles of fishmeal. The aquaculture feed containing fishmeal in combination with soy flake was produced according to the methods of the present disclosure, and the soy flake produced according to traditional methods.

Materials and Methods: All-male tilapia fingerling (starting weight 2.5 g) were stocked at normal stocking density (n=12/tank) in a recirculating system, in 38-L aquaria, maintained indoors in a climate-controlled laboratory. Photoperiod was set at 12 hours light/12 hours dark with fluorescent lights controlled by timers. Water quality was monitored weekly for total ammonia nitrogen, pH, dissolved oxygen, alkalinity and hardness, and was maintained throughout the trial at normal conditions.

Tanks were randomly assigned one of five dietary treatments (n=4 tanks/treatment) and fed their assigned diets for 10 weeks. Fish in all treatments were fed equally at a fixed rate beginning at 6% of body weight per day. The rate was decreased over time by 1% of body weight increments to keep the rate close to apparent satiation without overfeeding. The lowest feeding rate during the last few weeks of the trial was 3% of body weight.

Diets were maintained isonitrogenous and isocaloric. At the end of the feeding period, fish were weighed and then euthanized with tricaine methane sulfonate. Blood and tissue samples were collected and analyzed. Responses to be measured include weight gain (% of initial weight), survival rate, protein conversion efficiency (hepatosomatic index), proximate body composition (intraperitoneal fat ratio) and feed efficiency.

The results of the evaluation are provided in Tables 1 and 2. Table 1 provides the percentage of weight gain over various feeding periods through the 10 week trial.

TABLE 1

| | p = 0.003 | p < 0.001 | | |
|---|---|---|---|---|
| | Wk 1-5 | Wk 1-6 | p < 0.001 | p < 0.001 |
| | Weight | Weight | Wk 1-8 | Wk 1-10 |
| Test Group | gain % | gain % | gain % | gain % |
| Fishmeal | 454.5^{a} | 686.5^{a} | 1074^{a} | 1602^{a} |
| diet (basal) | | | | |
| 50:50 fish:processed | 447^{a} | 637.75^{a} | 1087^{a} | 1546.75^{a} |
| soy flake | | | | |
| Unprocessed | 315^{ab} | 426.5^{b} | 704.25^{b} | 999.25^{b} |
| Soy | | | | |
| negative | | | | |
| control | | | | |

(^{a-b}Within a column, means with different superscripts are significantly different)

The results of Table 1 show that aquaculture species ingesting the aquaculture feed produced according to the methods of the present disclosure, i.e., the 50:50 fish: processed soy flake group, showed an improvement in weight gain over weeks 1-8 of the trial compared to the basal diet group ingesting fishmeal and a substantial improvement in weight gain compared to the negative control group ingesting the unprocessed soy. After 10 weeks, the group ingesting the aquaculture feed produced according to the present disclosure showed a similar overall weight gain compared to the basal diet group, meaning the group ingesting the aquaculture feed of the present disclosure were not negatively impacted by the diet.

Table 2 provides the percentage of survival, hepatosomatic index percentage, intraperitoneal fat ratio percentage and feed efficiency through the 10 week trial.

TABLE 2

| | p = 0.56 | p = 0.13 | p = 0.15 | p = 0.04 |
|---|---|---|---|---|
| | Wk 1-10 | Hepatosomatic | Intraperitoneal fat | Feed |
| Test Group | survival % | index % | ratio % | Efficiency |
| Fishmeal | 75 | 0.98 | 0.65 | 0.84^{ab} |
| diet (basal) | | | | |
| 50:50 fish: | 54.15 | 1.00 | 0.87 | 0.90^{a} |
| processed | | | | |
| soy flake | | | | |
| Unprocessed | 70.85 | 0.76 | 0.54 | 0.72^{a} |
| Soy negative | | | | |
| control | | | | |

(^{a-b}Within a column, means with different superscripts are significantly different)

The results of Table 2 show that the aquaculture group ingesting the aquaculture feed produced according to the present disclosure experienced improvements in feed efficiency compared to the group ingesting the basal diet, and a substantial improvement over the negative control group. The levels of hepatosomatic index and intraperitoneal fat were similar enough between groups resulting in no meaningful difference between treatments. Although the survival rate of the group ingesting the aquaculture feed produced according to the present disclosure experienced a reduced survival rate, the reduced rate appears to be related to aggression of the tilapia (e.g., a genetic disposition based on historical research) rather than a nutritional issue.

Accordingly, the results of the Example show that the group ingesting the diet produced according to the present disclosure were not negatively impacted by the diet and showed improvements in protein conversion efficiency, and feed efficiency compared to the group ingesting the diet of fishmeal.

While the present disclosure provides various ranges, it will be understood that values, such as numeric integer values, at or within these ranges, or various ranges within the disclosed ranges, or ranges beginning or ending at a range value and beginning or ending at a value within the disclosed ranges may be used in particular embodiments without departing from the invention.

Although the present invention has been described with reference to specific embodiments, persons skilled in the art will recognize that changes may be made in form and detail without departing from the spirit and scope of the invention.

What is claimed is:

1. A method of forming an aquaculture feed, comprising:
combining a proteinaceous vegetable material with a proteinaceous fish material, alcohol and a reducing agent to form a mixture;
maintaining the mixture under pressure at an elevated cooking temperature sufficient to cook the proteinaceous fish material and release oil therefrom, wherein at least a portion of the oil is absorbed into the proteinaceous vegetable material to form a proteinaceous product from the mixture; and
removing all or essentially all of the alcohol by venting the pressure on the proteinaceous product to form the aquaculture feed, the aquaculture feed with enhanced protein digestibility and solubility.

2. The method of claim 1, wherein the aquaculture feed is formed of about 50 percent proteinaceous vegetable material.

3. The method of claim 2, wherein the aquaculture feed is formed of up to about 50 percent proteinaceous fish material.

4. The method of claim 1, further comprising pressing the mixture with the cooked proteinaceous fish material to remove another portion of the oil from the mixture.

5. The method of claim 1, wherein the pressure is greater than 10 per square inch gauge (psig) and the cooking temperature is greater than 90° C.

6. The method of claim 1, wherein the proteinaceous vegetable material comprises soy protein.

7. An aquaculture feed formed by the method of claim 1.

8. A method of forming an aquaculture feed, comprising:
combining a proteinaceous vegetable material with alcohol and a reducing agent to form a mixture;
maintaining the mixture at a temperature greater than 90° C. and a pressure greater than 10 psig for a holding period of at least about five minutes;
processing the heated and pressurized proteinaceous vegetable material with a proteinaceous fish material containing released oil, wherein at least a portion of the released oil is absorbed into the proteinaceous vegetable material; and
removing all or essentially all of the alcohol by venting the pressure on the proteinaceous product to form the aquaculture feed, the aquaculture feed with enhanced protein digestibility and solubility.

9. The method of claim 8, wherein the aquaculture feed is formed of about 50 percent proteinaceous vegetable material.

10. The method of claim 9, wherein the proteinaceous vegetable material is soy protein.

11. The method of claim 9, wherein the aquaculture feed is formed of up to about 50 percent proteinaceous fish material.

12. The method of claim 8, wherein the proteinaceous fish material containing the released oil is cooked fish.

13. The method of claim 8, wherein processing the proteinaceous vegetable product with the proteinaceous fish material further comprises pressing to further cause the released oil to be absorbed into the proteinaceous vegetable material.

14. The method of claim 8, further comprising drying the aquaculture feed.

15. The method of claim 14, further comprising reducing a particle size of the dried aquaculture feed.

16. An aquaculture feed formed by the method of claim 8.

17. A method of feeding aquaculture, the method comprising:
providing aquaculture species an aquaculture feed formed of about 50 percent proteinaceous vegetable material and up to about 50 percent proteinaceous fish material, wherein the proteinaceous vegetable material includes a glycinin level of not more than 11 mg/g and a β-conglycinin of not more than 0.4 mg/g.

18. The method of claim 17, wherein the aquaculture species ingesting the aquaculture feed is a first group and aquaculture species ingesting a diet of fishmeal that is free of the proteinaceous vegetable material is a second group, the aquaculture species in first and the second group being substantially the same, and wherein the first group exhibits an improved feed efficiency compared to the second group.

19. The method of claim 17, wherein the aquaculture species ingesting the aquaculture feed is a first group and aquaculture species ingesting a diet of fishmeal that is free of proteinaceous vegetable material is a second group, the aquaculture species in first and the second group being substantially the same, and wherein the first group exhibits increased weight gain over an eight week feeding period compared to the second group.

20. The method of claim 17, wherein the aquaculture species are juvenile aquaculture.
